(19) United States
(12) Patent Application Publication
(10) Pub. No.: US 2022/0018967 A1
(43) Pub. Date: Jan. 20, 2022

(54) METHODS AND APPARATUSES FOR SECURING OPTICAL MODULES IN A LiDAR SYSTEM

(71) Applicant: Beijing Voyager Technology Co., Ltd., Beijing (CN)

(72) Inventors: Anan Pan, Fremont, CA (US); Henghui Jiang, Newark, CA (US)

(21) Appl. No.: 16/933,699

(22) Filed: Jul. 20, 2020

(51) Int. Cl. G01S 17/931; G01S 7/481

(52) U.S. Cl. CPC G01S 17/931; G01S 7/4813

(57) ABSTRACT

An optical module of a Light Detection and Ranging (LiDAR) module for a vehicle can include a frame, a front plate, a rear plate, and a transmission module. The frame can include a base, four pillars extending from the base, and four beams extending between the pillars opposite the base. The transmission module can include a chassis, a laser module and an optical lens module. The front plate and rear plate can be coupled to the frame to define a support structure. The transmission module may be secured to the support structure by slidably coupling the chassis of the transmission module to the front plate and the rear plate, and securing the chassis to at least one of the front plate and the rear plate with a fastener so that the fastener and the slidable coupling restrain the transmission module to the support structure in six degrees of freedom.

### BACKGROUND

Modern vehicles are often equipped with sensors designed to detect objects and landscape features around the vehicle in real-time to enable technologies such as lane change assistance, collision avoidance, and autonomous driving. A commonly used sensor is a light detection and ranging (LiDAR) system.

A LiDAR system may include a light source, also referred to as a transmission module, and a light detection system, also referred to as a receiver module, to estimate distances to environmental features (e.g., pedestrians, vehicles, structures, plants, etc.). The transmission module may include a laser module and an optical lens assembly. The laser module may include a circuit board mounted laser configured to emit a laser beam that is optically aligned with the optical lens assembly. The emitted laser beam is used to illuminate a target and the LiDAR system measures the time it takes for the transmitted laser beam to arrive at the target and then return to the receiver module. In some LiDAR systems, the laser beam may be steered across a region of interest according to a scanning pattern to generate a “point cloud” that includes a collection of data points corresponding to target points in the region of interest. The data points in the point cloud may be dynamically and continuously updated, and may be used to estimate, for example, a distance, dimension, and location of an object relative to the LiDAR system, often with very high fidelity (e.g., within about 5 cm) due to the precision of the optical alignment of the components.

### BRIEF SUMMARY

In embodiments, the present technology includes a method of assembling an optical module of a LiDAR system. The method may include providing a frame. The frame may include a base, a front left pillar extending from the base, a front right pillar extending from the base, a rear left pillar extending from the base, a rear right pillar extending from the base, a top front beam extending between the front left pillar and the front right pillar, a rear front beam extending between the rear left pillar and the rear right pillar a top left beam extending between the front left pillar and the rear left pillar, and a top right beam extending between the front right pillar and the rear right pillar, wherein the frame is monolithic. The method may further include fixedly coupling a front plate to the base and the top front beam so that the front plate contacts the front left pillar. The method may further include fixedly coupling a rear plate to the base and the top right beam, wherein the frame, the front plate and the rear plate define a support structure. The method may further include slidably coupling a transmission module to the support structure, wherein the slidable coupling restrains the transmission module to the support structure in five degrees of freedom, and wherein the transmission module comprises a chassis, a laser module and an optical lens module. The method may further include securing the chassis to at least one of the front plate and the rear plate with a first fastener so that the first fastener and the slidable coupling restrain the transmission module to the support structure in six degrees of freedom.

In embodiments, the front plate may include a first groove facing the rear plate, and the chassis of the transmission module may include a front rail. In embodiments, slidably coupling the transmission module to the support structure may include slidably engaging the front rail with the first groove. In embodiments, the rear plate may include a second groove facing the front plate, the chassis of the transmission module may include a rear rail, and slidably coupling the transmission module to the support structure may include slidably engaging the rear rail with the second groove.

In embodiments, the front plate may include a third groove facing the rear plate, and the rear plate may include a fourth groove facing the front plate. In embodiments, the method may include slidably coupling a second transmission module to the support structure by engaging a second front rail of the second transmission module with the third groove and engaging a second rear rail of the second transmission module with the fourth groove. In embodiments, the LiDAR system may include a galvanometer mirror assembly, the base may include a central mounting block coupled to the galvanometer mirror assembly, and the rear plate may include a faceted recess. The coupling of the rear plate to the frame may include engaging the faceted recess with side surfaces of the central mounting block.

In embodiments, a light transmission opening may be defined between the front plate, the base, the front right pillar, and the top front beam. The central mounting block and the galvanometer mirror assembly may be positioned so that a laser beam emitted from the transmission module reflects off the galvanometer mirror assembly and through the light transmission opening.

In embodiments, the frame may include a left mounting block extending from the base and the rear left pillar, and a right mounting block extending from the base and the rear right pillar. A left side of the rear plate may be coupled to the left mounting block with a second fastener and a right side of the rear plate is coupled to the right mounting block with a third fastener, so that a bottom side of the rear plate contacts the base. The left side of the rear plate may be coupled to the top left beam with a fourth fastener and the right side of the rear plate may be coupled to the top right beam with a fifth fastener.

In embodiments, the base of the frame may define a first slot and a second slot, and coupling the front plate to the frame may include positioning a first bracket in the first slot and a second bracket in the second slot, and coupling the front plate to the first bracket with a sixth fastener and to the second bracket with a seventh fastener so that a bottom side of the front plate contacts the base and a left side of the front plate contacts the front left pillar. In embodiments, coupling the front plate to the frame further may include coupling a top side of the front plate to the top front beam with an eighth fastener so that a top side of the front plate contacts the top front beam.

In embodiments, an optical module of a LiDAR system may include a frame comprising a base, a front left pillar extending from the base, a front right pillar extending from the base, a rear left pillar extending from the base, a rear right pillar extending from the base, a top front beam extending between the front left pillar and the front right pillar, a rear front beam extending between the rear left pillar and the rear right pillar, a top left beam extending between the front left pillar and the rear left pillar, and a top right beam extending between the front right pillar and the rear right pillar. The frame may be monolithic. The optical module may further include a front plate coupled to the base and the top front beam so that the front plate contacts the front left pillar, and a rear plate coupled to the base and the top right beam. The frame, the front plate and the rear plate may define a support structure. The optical module may further include a transmission module including a chassis, a laser module and an optical lens module. The transmission module may be slidably coupled to the support structure so that the slidable coupling restrains the transmission module to the support structure in five degrees of freedom, and the chassis of the transmission module may be secured to at least one of the front plate and the rear plate with a first fastener so that the first fastener and the slidable coupling restrain the transmission module to the support structure in six degrees of freedom.

In embodiments, the front plate of the optical module may include a first groove facing the rear plate, the chassis of the transmission module may include a front rail, and the slidable coupling may include the front rail engaging with the first groove. The rear plate may include a second groove facing the front plate, the chassis of the transmission module may include a rear rail, and the slidable coupling may include the rear rail engaging with the second groove. The optical module may include a second transmission module, the front plate may include a third groove facing the rear plate, the rear plate may include a fourth groove facing the front plate, and the second transmission module may be slidably coupled to the support structure by a second front rail of the second transmission module engaging with the third groove and a second rear rail of the second transmission module engaging with the fourth groove.

In embodiments, an optical module may include a galvanometer mirror assembly, the base may include a central mounting block coupled to the galvanometer mirror assembly, the rear plate may include a faceted recess, and the faceted recess may engage with side surfaces of the central mounting block. A light transmission opening may be defined between the front plate, the base, the front right pillar, and the top front beam. The central mounting block and the galvanometer mirror assembly may be positioned so that a laser beam emitted from the transmission module reflects off the galvanometer mirror assembly and through the light transmission opening.

In embodiments, the frame may include a left mounting block extending from the base and the rear left pillar, and a right mounting block extending from the base and the rear right pillar. A left side of the rear plate may be coupled to the left mounting block with a second fastener and a right side of the rear plate is coupled to the right mounting block with a third fastener, so that a bottom side of the rear plate contacts the base. The left side of the rear plate may be coupled to the top left beam with a fourth fastener and the right side of the rear plate may be coupled to the top right beam with a fifth fastener.

This summary is not intended to identify key or essential features of the claimed subject matter, nor is it intended to be used in isolation to determine the scope of the claimed subject matter. The subject matter should be understood by reference to appropriate portions of the entire specification of this disclosure, any or all drawings, and each claim.

The foregoing, together with other features and examples, will be described in more detail below in the following specification, claims, and accompanying drawings.

### BRIEF DESCRIPTION OF THE DRAWINGS

The features of the various embodiments described above, as well as other features and advantages of certain embodiments of the present invention will be more apparent from the following detailed description taken in conjunction with the accompanying drawings, in which:

FIGS. 1A and 1B show views of an optical assembly of an autonomous vehicle LiDAR system, according to certain embodiments;

FIGS. 2A-2F show views of a frame, according to certain embodiments;

FIGS. 3A and 3B show views of a rear plate, according to certain embodiments;

FIGS. 4A and 4B show views of coupling a rear plate to a frame, according to certain embodiments;

FIGS. 5A and 5B show views of a front plate, according to certain embodiments;

FIGS. 6A and 6B show views of coupling a front plate to a frame, according to certain embodiments;

FIGS. 7A and 7B show views a transmission module, according to certain embodiments; and

FIGS. 8A-8F show views of coupling a transmission module to a support structure including a frame, a front plate and a rear plate, according to certain embodiments.

Throughout the drawings, it should be noted that like reference numbers are typically used to depict the same or similar elements, features, and structures.

### DETAILED DESCRIPTION

Aspects of the present disclosure relate generally to securing optical components to a frame. The frame and optical components may be part of a LiDAR system, according to certain embodiments.

In the following description, various examples of securing optical components to a frame are described. For purposes of explanation, specific configurations and details are set forth in order to provide a thorough understanding of the embodiments. However, it will be apparent to one skilled in the art that certain embodiments may be practiced or implemented without every detail disclosed. Furthermore, well-known features may be omitted or simplified in order to prevent any obfuscation of the novel features described herein.

The following high-level summary is intended to provide a basic understanding of some of the novel innovations depicted in the figures and presented in the corresponding descriptions provided below. Generally, aspects of the invention are directed to implementations of fixedly coupling optical components, for example a transmission module (TX) or combination transmission and receiver module (TX/RX) to a support structure so that the optical components are optically aligned with each other. The optical components of a LiDAR system are precisely optically aligned in order for the LiDAR to makes accurate measurements, particularly at longer ranges. In order to maintain optical alignment between optical components that are used together, the optical components may be fixedly coupled to a common support structure in order to restrain movement in the six degrees of freedom, i.e. XYZ translation and XYZ rotation. One method of fixedly coupling an optical component to a support structure is to use one or more fasteners, e.g. screws/bolts, to clamp the optical component against the support structure. The one or more fasteners may be the primary means for restraining movement in the six degrees of freedom. One disadvantage of using fasteners as the primary means for restraint is that fasteners may require an exact torque to achieve and maintain optical alignment. For example, over or under tightening a fastener may cause the coupled components to shift from optically aligned to not optically aligned. Further, due to various manufacturing tolerances of the different components, e.g. optical components, fasteners and the support structure, the exact torque needed for optical alignment may be unique to a particular combination of components. Therefore, achieving optical alignment may be a time consuming task of applying many combinations of different torques to the multiple fasteners in order to determine a combination that leads to optical alignment of all of the components. This process may need to be performed during the assembly of each optical assembly since a combination of torques leading to optical alignment in one optical assembly may be different than a combination of torques leading to optical alignment in another optical assembly due to minor differences in the components, for example due to manufacturing tolerances.

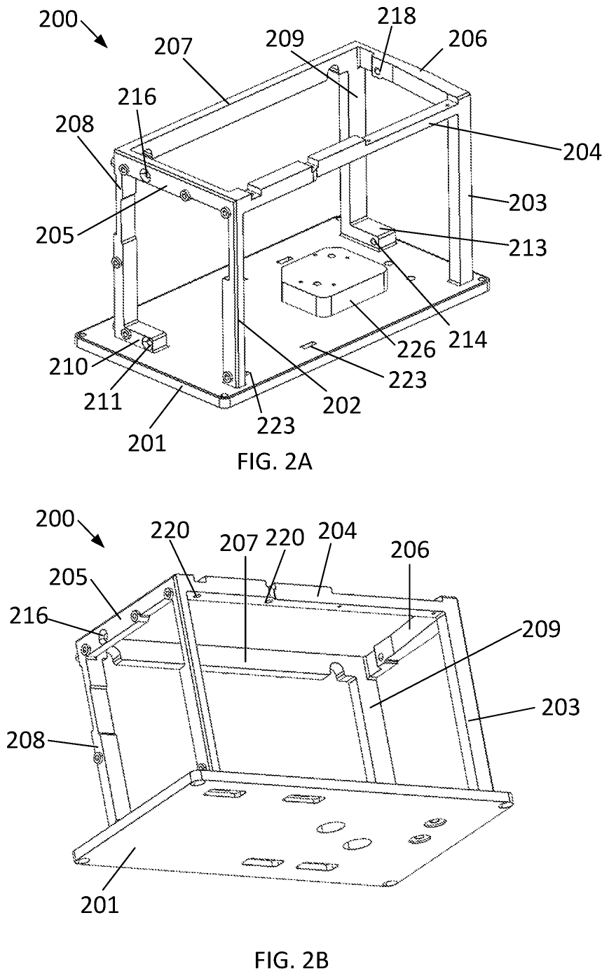

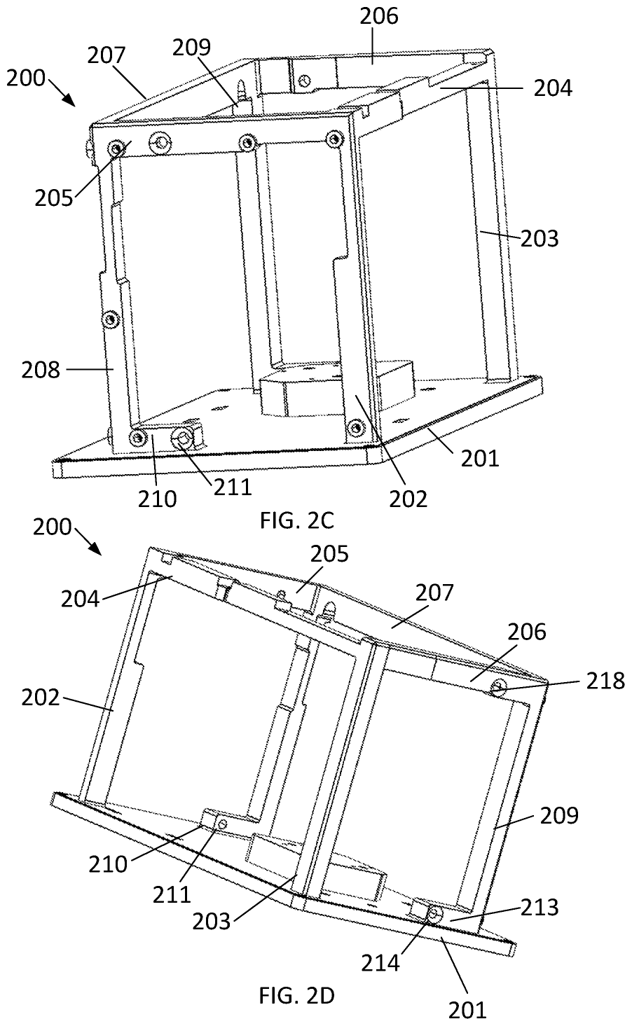

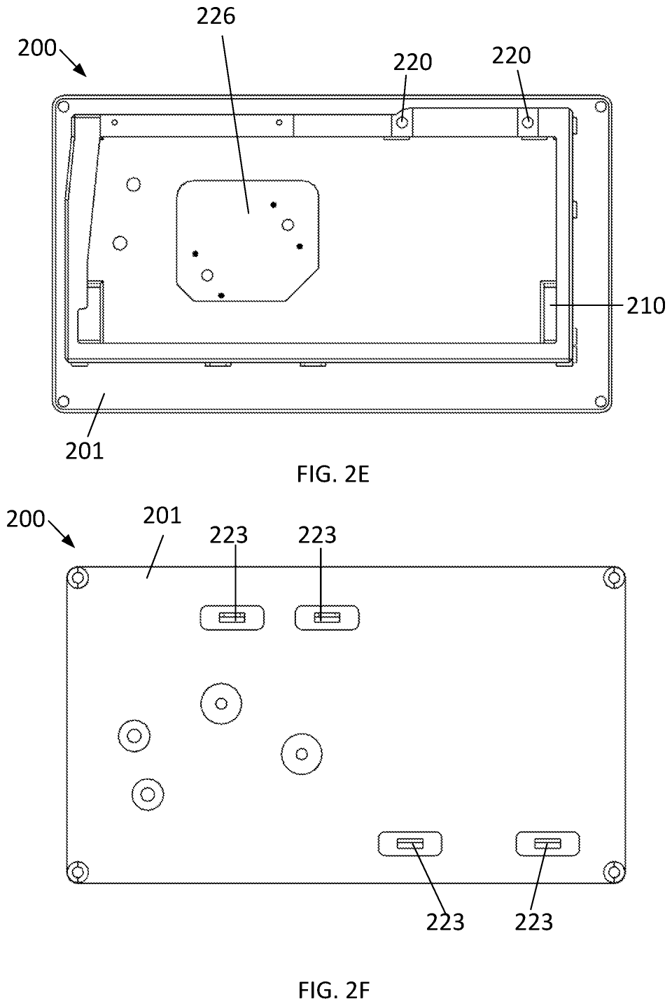

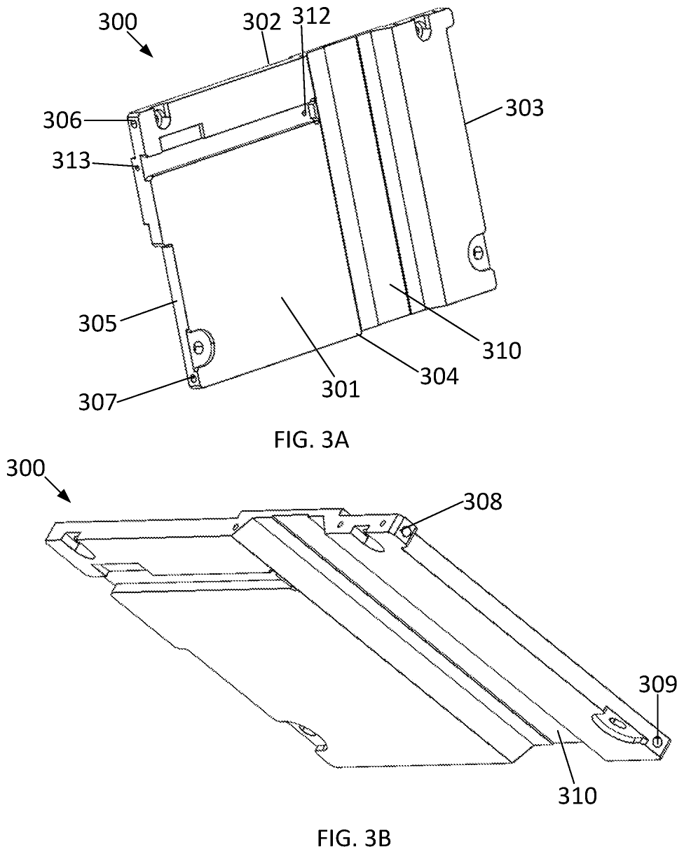

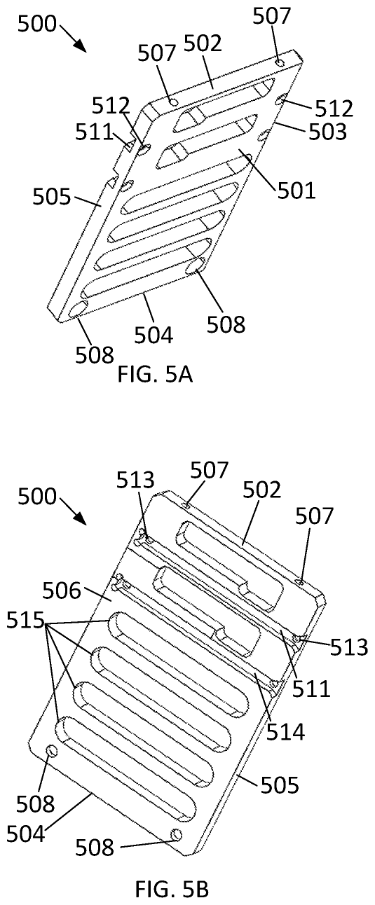

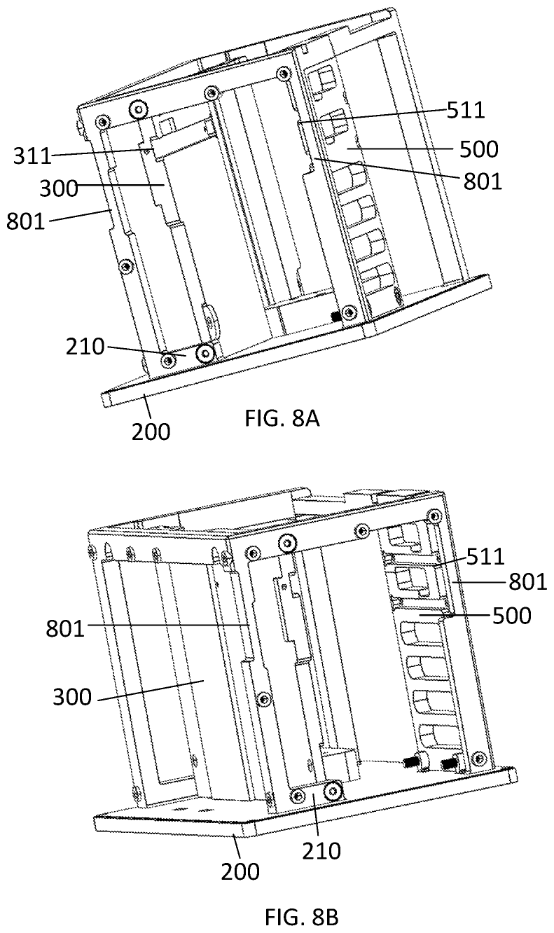

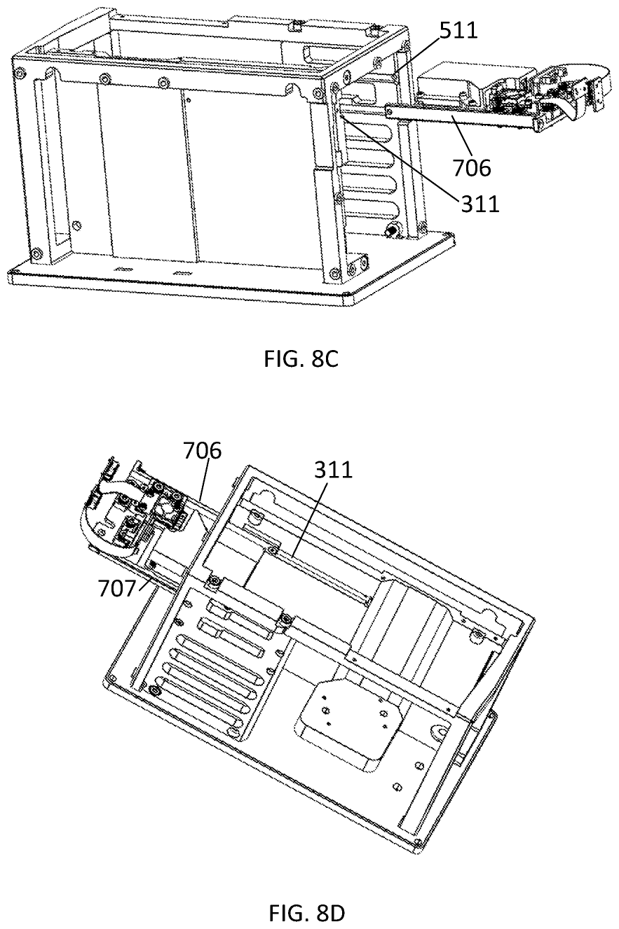

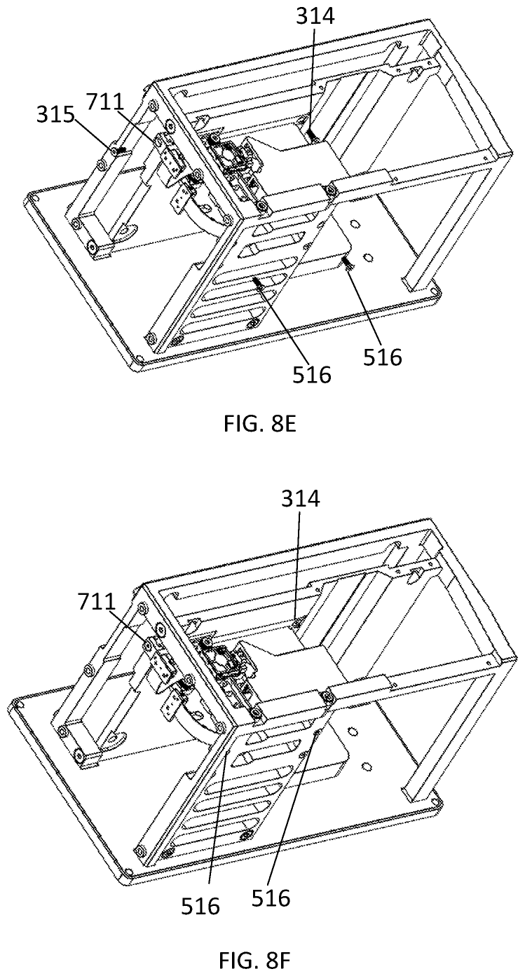

The present technology relates to securing a transmission module (TX) or combination transmission and receiver module (TX/RX) to a support structure, wherein fasteners are not the primary means of restraint for coupling the components together. Specifically, the support structure comprises a frame, for example as shown in FIGS. 2A-2F, a rear plate, for example as shown in FIGS. 3A and 3B, and a front plate, for example as shown in FIGS. 5A and 5B. The frame, rear plate and front plate, are coupled together to form a support structure defining two parallel grooves for receiving the chassis of a transmission module, for example as shown in FIGS. 8A-8F. The engagement of the chassis of the transmission module with the grooves of the support structure provides the primary means of restraint coupling the transmission module to the support structure. With the chassis of the transmission module within the grooves, fasteners may be used as a secondary means of restraint to prevent movement of the chassis of the transmission module relative to the support structure in a single direction of translation out of the grooves. The figures are further described in greater detail below and the scope of the various embodiments of the present invention is not limited by this summary, which merely operates to present a high-level understanding of some of the novel concepts that follow.

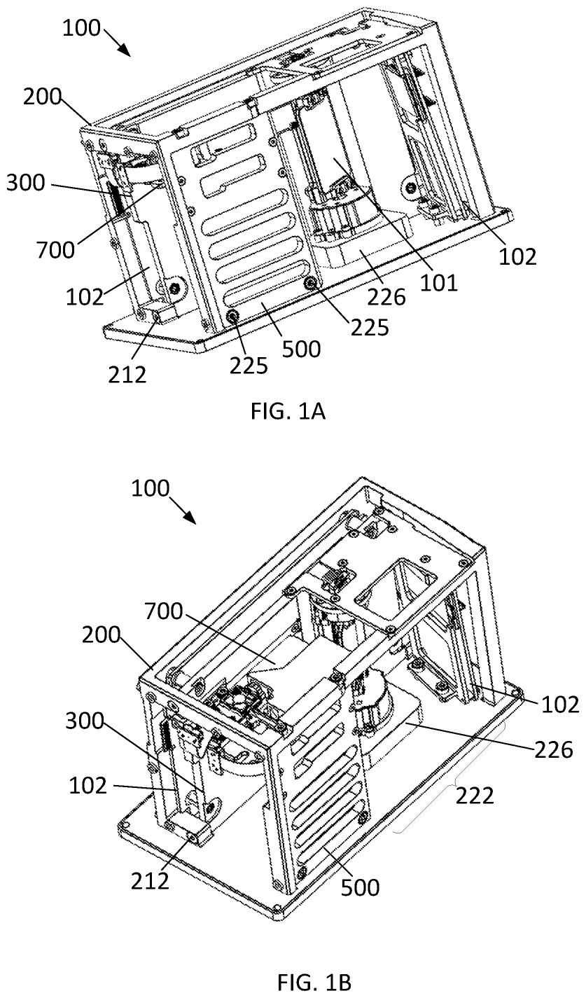

FIGS. 1A and 1B show views of an optical assembly 100 of an autonomous vehicle LiDAR system, according to certain embodiments. As shown, the optical assembly 100 comprises a frame 200, a rear plate 300, a front plate 500, and a transmission module 700. As used herein the term transmission module may refer to modules comprising transmission components, e.g. TX modules, as well as modules with both transmission and receiving components, e.g. TX/RX modules.

As shown in FIG. 1A, the optical assembly 100 may further comprise a galvanometer mirror assembly 101 for steering a beam of light emitted from the transmission module 700. As shown, the front plate 500 does not extend across the width of the front side of the frame 200 in order to define a light transmission opening through which light passes in and out of the optical assembly 100 and reflects between the environment and the transmission module 700.

The optical assembly 100 may further comprise one or more circuit boards 102 coupled to the frame 200. The circuit boards 102 may be electrically coupled to one or more of the transmission module 700, the galvanometer mirror assembly 101, other circuit boards 102, or other components in the LiDAR system.

FIG. 2A shows an embodiment of a frame 200. The frame comprises, a base 201. The base 201 may be rectangular. The frame further comprises a plurality of frame elements including: a front left pillar 202, a front right pillar 203, a front top beam 204, a top left beam 205, a top right beam 206, a rear top beam 207, a rear left pillar 208, and a rear right pillar 209. As used herein, directional terms, for example front, rear, top, bottom, left and right, are used to designate directions and orientations relative to other components, and do not limit the orientation of the components relative to other coordinate systems. The frame elements may have generally rectangular cross-sections.

As shown, with a rectangular base 201, the four pillars 202, 203, 208 and 209 extend away from the base proximate to respective corners of the base 201. Further, the four beams 205, 206, 207 and 208, connect the ends of the pillars 202, 203, 208 and 209 opposite the base 201. Specifically, the top left beam 205 extends between the rear left pillar 208 and the front left pillar 202. The front top beam 204 extends between the front left pillar 202 and the front right pillar 203. The top right beam 206 extends between the front right pillar 203 and the rear right pillar 209. The rear top beam 207 extends between the rear right pillar 209 and the rear left pillar 208.

As shown, the base 201 and frame elements define a rectangular prism comprising one closed side at the base 201, and five open sides. The open sides define generally rectangular openings. As shown in FIG. 2A, a left side of the frame 200 may comprise a left mounting block 210 extending away from the base 201 and the rear left pillar 208 at a corner of the left opening. The left mounting block 210 defines an outer surface facing away from the center of the frame and an inner surface facing toward the center of the frame. A hole 211 may extend between the outer surface and the inner surface for receiving a fastener 212 to couple the rear plate 300 to the frame 200.

As shown in FIG. 2A, a right side of the frame may comprise a right mounting block 213 extending away from the base 201 and the rear right pillar 209 at a corner of the right opening. The right mounting block 213 defines an outer surface facing away from the center of the frame and an inner surface facing toward the center of the frame 200. A hole 214 may extend between the outer surface and the inner surface for receiving a fastener 215 to couple the rear plate 300 to the frame 200.

The top left beam 205 defines an outer surface facing away from the center of the frame and an inner surface facing toward the center of the frame. A hole 216 may extend between the outer surface and the inner surface for receiving a fastener 217 to couple the rear plate 300 to the frame 200. The top right beam 206 defines an outer surface facing away from the center of the frame and an inner surface facing toward the center of the frame. A hole 218 may extend between the outer surface and the inner surface for receiving a fastener 219 to couple the rear plate 300 to the frame 200.

The front top beam 204 defines a top surface facing away from the base of the frame 200 and a bottom surface facing toward the base 201 of the frame 200. One or holes 220 may extend between the top surface and the bottom surface for receiving a fastener 221 to couple the front plate 500 to the frame 200. As shown in FIG. 2B, the holes 220 may be more proximate to the left side than the right side of the frame 200 so that the front plate 500 is coupled to the left side of the front opening leaving the right side of the front opening unobstructed to form a light transmission opening 222.

The base 201 defines a plurality of slots 223 extending from the bottom side to the top side of the base 201 for receiving brackets 224 used to receive fasteners 225 to couple components to the frame. The frame 200 may further comprise a central mounting block 226 extending from the base 201 toward the top side for mounting a galvanometer mirror assembly 101 as shown for example in FIG. 1A. As shown in FIG. 2E, the central mounting block 226 may comprise a plurality of side surfaces facing the rear side of the frame 200.

In order to provide structural support, the frame 200 may be monolithic, and may be formed of a rigid material, such as aluminum, via machining, casting, or a combination thereof.

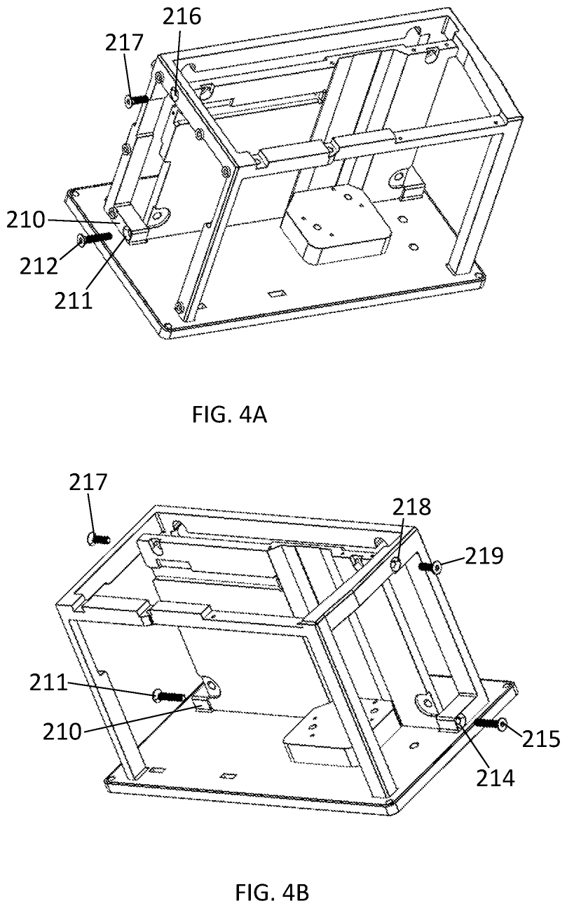

FIGS. 3A and 3B show an embodiment of a rear plate 300. The rear plate 300 may be a generally rectangular planar body. The rear plate comprises a front face 301, a top side 302, a right side 303, a bottom side 304, and a left side 305. The left side 305 defines a top hole 306 and a bottom hole 307. The right side defines a top hole 308 and a bottom hole 309. As shown in FIGS. 4A and 4B, the rear plate 300 is coupled to the frame 200 with fastener 212 extending through hole 211 into bottom hole 307, with fastener 217 extending through hole 216 into top hole 306, with fastener 219 extending through hole 218 into top hole 308, and with fastener 215 extending through hole 214 into bottom hole 309.

As shown in FIGS. 4A and 4B, the rear plate 300 is positioned with the bottom side 304 against the base 201, the left side 305 against the top left beam 205 and the left mounting block 210, and the right side 303 against the top right beam 206 and right mounting block 213. The engagement of the rear plate and surfaces of the frame restrain the rear plate relative to the frame, and the fasteners extending through the frame into the rear plate may further restrain the rear plate relative to the frame.

As shown in FIGS. 3A and 3B, the right side of the front face 301 defines a recess 310 corresponding in shape and size with the side surfaces of the central mounting block 226. As shown in FIGS. 4A and 4B, with the rear plate 300 coupled to the frame 200 the recess 310 engages the side surface of the central mounting block 226, and as shown in FIG. 1A the recess is positioned around the galvanometer mirror assembly 101 in order to provide clearance for a rotating mirror of the galvanometer mirror assembly 101.

The front face 301 of the rear plate further comprises a groove 311. In embodiments, the groove 311 may be rectangular and extend between the recess 310 and the left side 305. As will be discussed in greater detail below, the groove 311 may slidably engage with a portion of the transmission module 700 in order to slidably couple the transmission to the support structure comprising the frame 200, rear plate 300, and front plate 500. The groove may comprise a hole 312 proximate to the recess 310. Further, the left side 305 may comprise a hole 313. Holes 312 and 313 may be used to receive fasteners used to prevent the transmission module 700 from sliding out of the groove 311. In embodiments, the front face 301 may comprise additional grooves parallel to groove 311 for slidably coupling multiple transmission modules 700 to the support structure.

FIGS. 5A and 5B show an embodiment of a front plate 500. The front plate 500 may be a generally rectangular planar body. The front plate 500 comprises a front face 501, a top side 502, a right side 503, a bottom side 504, a left side 505, and a rear face 506. The top side 502 defines holes 507. The front plate 500 further comprises holes 508 extending between the front face 501 and the rear face 506 proximate to the bottom side 504.

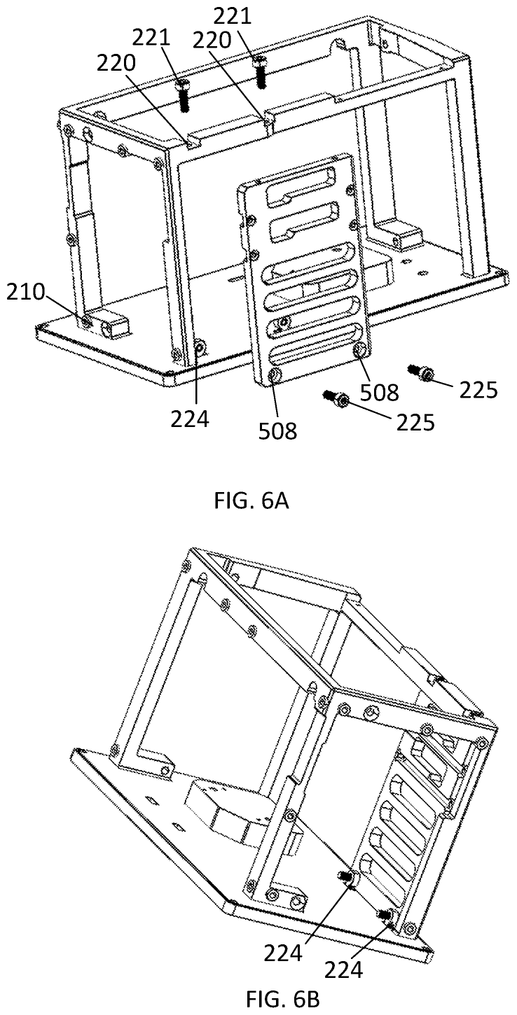

As shown in FIGS. 6A and 6B, the front plate 500 is coupled to the frame 200 with fasteners 221 extending through holes 220 into holes 507, and with fasteners 225 extending through holes 508 into brackets 224. The front plate 500 is positioned with the bottom side 504 against the base 201, the left side 505 against the front left pillar 202 and the top side 502 against front top beam 204. The engagement of the front plate and surfaces of the frame restrain the front plate relative to the frame, and the fasteners extending through the frame into the front plate may further restrain the front plate relative to the frame.

The rear face 506 of the front plate 500 further comprises a groove 511. In embodiments, the groove 511 may be rectangular and extend between the right side 503 and the left side 505. As will be discussed in greater detail below, the groove 511 may slidably engage with a portion of the transmission module 700 in order to slidably couple the transmission to the support structure comprising the frame 200, rear plate 300, and front plate 500. The groove 511 may comprise holes 512 proximate to ends of the groove 511. Holes 512 may be used to receive fasteners 516 used to prevent the transmission module 700 from sliding out of the groove 511. In embodiments, the rear face 506 of the front plate 500 may comprise additional grooves 514 parallel to groove 511 for slidably coupling multiple transmission modules 700 to the support structure. The front plate 500 may comprise a plurality of elongated slot 515 in order to provide surface area heat dissipation, for example to dissipate heat generated by a laser of a transmission module 700.

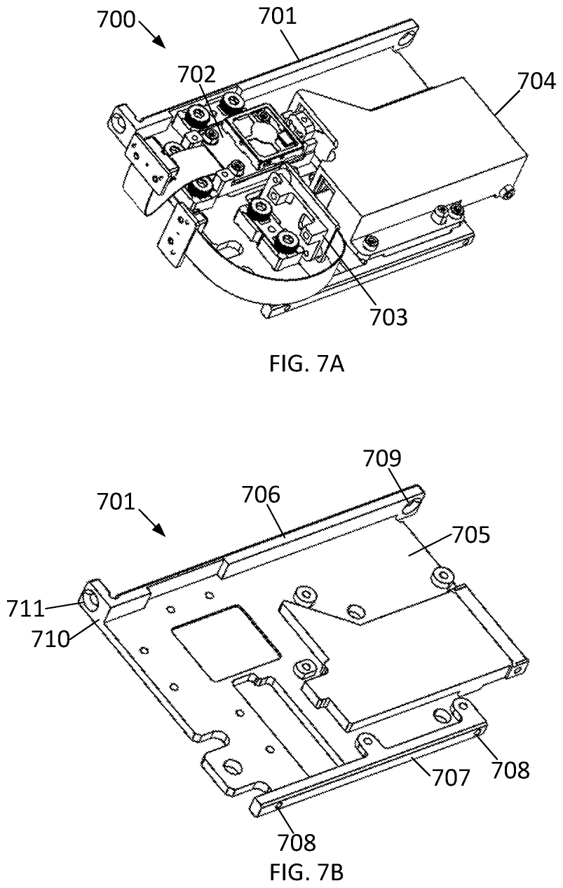

FIG. 7A shows an embodiment of a transmission module 700. The transmission module includes a chassis 701, a laser module 702, a light receiving module 703, and an optical lens module 704. FIG. 7B shows an embodiment of a chassis 701. As shown the chassis 701 comprises a base 705 to which the laser module 702, light receiving module 703 and optical lens module 704 are mounted. The chassis 701 comprises a rear rail 706 on a first side of the base 705, and a front rail 707 a second side of the base 705, opposite the first side. The front rail 707 is sized and shaped to be received within the groove 511 of the front plate 500, and may be generally rectangular. The front rail 707 defines holes 708 oriented to correspond to the holes 513 of the front plate 500 and receive fasteners 516 when the transmission module 700 is in an installed configuration. The rear rail 706 is sized and shaped to be received within the groove 311 of the rear plate 300. The rear rail 706 defines a hole 709 oriented to correspond to the hole 312 of the rear plate 300 and receive fasteners 314 when the transmission module 700 is in an installed configuration. The chassis 701 further defines a stop tab 710 at an end of the rear rail 706 opposite the hole 709. The stop tab 710 extends perpendicularly to the rear rail 706 and defines a hole 711. In the installed configuration, the hole 711 of the stop tab 710 receives a fastener 315 extending into hole 313 on the left side of the rear plate 300.

FIGS. 8A-8H show views of assembling an optical assembly of a LiDAR system. As shown in FIGS. 8A and 8B, a support structure is provided including the frame 200, rear plate 300 and front plate 500. The rear plate 300 and front plate 500 may be coupled to the frame, for example as shown in FIGS. 4A, 4B, 6A, 6B, and may be coupled in any order. As shown, groove 311 faces groove 511 to define a sliding path for the transmission module. Further, as shown, in embodiments, the front left pillar 202 and rear left pillar 208 may include a narrowed portion 801, defining a wider portion of the left opening of the frame 200 for receiving the transmission module 700.

FIGS. 8C and 8D show views of inserting the transmission module 700 into the grooves 311 and 511 in order to initiate a slidable coupling of the transmission module 700 and the support structure. As shown in FIG. 8C, the rear rail 706 may be aligned with groove 311 and the front rail 707 may be aligned with groove 511. The transmission module 700 may continue to be inserted into the groove 311 and 511 until reaching the installed configuration, as shown for example in FIG. 8E. In the installed configuration, hole 709 is aligned over hole 312, holes 708 are aligned over holes 513, and stop tab 710 contacts the left side 305 of the rear plate 300 with hole 711 aligned over hole 313. In the installed configurable, the slidable coupling of the front and rear rails 707 and 706 engaging with groove 311 and 511 restrains movement the transmission in at least five of the six degrees of freedom, i.e. XYZ translation and XYZ rotation. The only movement not fully restrained by the slidable coupling it translation of the transmission module 700 out of the grooves 311 and 511. To prevent translation of transmission module 700, fasteners may be extended through the chassis 701 into at least one of the rear plate 300 and the front plate. For example, as shown in FIG. 8F, fasteners 516 may extend through holes 513 and threadedly couple into holes 708, fastener 314 may extend through hole 709 and threadedly couple to hole 312, and/or fastener 315 may extending through hole 711 and threadedly couple to hole 313. Due to the slidabe coupling of the transmission module to the support structure, the torque for tightening the fasteners 314, 516, and 711 does not have an effect of the alignment of the transmission module 700.

Other variations are within the spirit of the present disclosure. Thus, while the disclosed techniques are susceptible to various modifications and alternative constructions, certain illustrated examples thereof are shown in the drawings and have been described above in detail. It should be understood, however, that there is no intention to limit the disclosure to the specific form or forms disclosed, but on the contrary, the intention is to cover all modifications, alternative constructions and equivalents falling within the spirit and scope of the disclosure, as defined in the appended claims. For instance, any of the examples, alternative examples, etc., and the concepts thereof may be applied to any other examples described and/or within the spirit and scope of the disclosure.

The use of the terms “a” and “an” and “the” and similar referents in the context of describing the disclosed examples (especially in the context of the following claims) are to be construed to cover both the singular and the plural, unless otherwise indicated herein or clearly contradicted by context. The terms “comprising,” “having,” “including,” and “containing” are to be construed as open-ended terms (i.e., meaning “including, but not limited to,”) unless otherwise noted. The term “connected” is to be construed as partly or wholly contained within, attached to, or joined together, even if there is something intervening. The phrase “based on” should be understood to be open-ended, and not limiting in any way, and is intended to be interpreted or otherwise read as “based at least in part on,” where appropriate. Recitation of ranges of values herein are merely intended to serve as a shorthand method of referring individually to each separate value falling within the range, unless otherwise indicated herein, and each separate value is incorporated into the specification as if it were individually recited herein. All methods described herein can be performed in any suitable order unless otherwise indicated herein or otherwise clearly contradicted by context. The use of any and all examples, or exemplary language (e.g., “such as”) provided herein, is intended merely to better illuminate examples of the disclosure and does not pose a limitation on the scope of the disclosure unless otherwise claimed. No language in the specification should be construed as indicating any non-claimed element as essential to the practice of the disclosure.

What is claimed is:

1. A method of assembling an optical module of a LiDAR system, the method comprising:
providing a frame comprising:
a base;
a front left pillar extending from the base;
a front right pillar extending from the base;
a rear left pillar extending from the base;
a rear right pillar extending from the base;
a top front beam extending between the front left pillar and the front right pillar;
a rear front beam extending between the rear left pillar and the rear right pillar;
a top left beam extending between the front left pillar and the rear left pillar; and
a top right beam extending between the front right pillar and the rear right pillar, wherein the frame is monolithic;
fixedly coupling a front plate to the base and the top front beam so that the front plate contacts the front left pillar; and
fixedly coupling a rear plate to the base and the top right beam, wherein the frame, the front plate and the rear plate define a support structure;
slidably coupling a transmission module to the support structure, wherein the slidable coupling restrains the transmission module to the support structure in five degrees of freedom, and wherein the transmission module comprises a chassis, a laser module and an optical lens module; and
securing the chassis to at least one of the front plate and the rear plate with a first fastener so that the first fastener and the slidable coupling restrain the transmission module to the support structure in six degrees of freedom.

2. The method of claim 1, wherein the front plate comprises a first groove facing the rear plate,
wherein the chassis of the transmission module comprises a front rail, and
wherein slidably coupling the transmission module to the support structure comprises slidably engaging the front rail with the first groove.

3. The method of claim 2, wherein the rear plate comprises a second groove facing the front plate,
wherein the chassis of the transmission module comprises a rear rail, and
wherein slidably coupling the transmission module to the support structure further comprises slidably engaging the rear rail with the second groove.

4. The method of claim 3, wherein the front plate comprises a third groove facing the rear plate,
wherein the rear plate comprises a fourth groove facing the front plate,
wherein the method further comprises:
slidably coupling a second transmission module to the support structure by engaging a second front rail of the second transmission module with the third groove and engaging a second rear rail of the second transmission module with the fourth groove.

5. The method of claim 3, wherein the LiDAR system comprises a galvanometer mirror assembly,
wherein the base comprises a central mounting block coupled to the galvanometer mirror assembly,
wherein the rear plate comprises a faceted recess, and
wherein coupling the rear plate to the frame comprises engaging the faceted recess with side surfaces of the central mounting block.

6. The method of claim 5, wherein a light transmission opening is defined between the front plate, the base, the front right pillar, and the top front beam,
wherein the central mounting block and the galvanometer mirror assembly are positioned so that a laser beam emitted from the transmission module reflects off the galvanometer mirror assembly and through the light transmission opening.

7. The method of claim 1, wherein the frame further comprises a left mounting block extending from the base and the rear left pillar, and a right mounting block extending from the base and the rear right pillar, and
wherein a left side of the rear plate is coupled to the left mounting block with a second fastener and a right side of the rear plate is coupled to the right mounting block with a third fastener, so that a bottom side of the rear plate contacts the base.

8. The method of claim 7, wherein the left side of the rear plate is coupled to the top left beam with a fourth fastener and the right side of the rear plate is coupled to the top right beam with a fifth fastener.

9. The method of claim 1, wherein the base of the frame defines a first slot and a second slot;
wherein coupling the front plate to the frame comprises positioning a first bracket in the first slot and a second bracket in the second slot, and coupling the front plate to the first bracket with a sixth fastener and to the second bracket with a seventh fastener so that a bottom side of the front plate contacts the base and a left side of the front plate contacts the front left pillar.

10. The method of claim 9, wherein coupling the front plate to the frame further comprises coupling a top side of the front plate to the top front beam with an eighth fastener so that a top side of the front plate contacts the top front beam.

11. An optical module of a LiDAR system, comprising:
a frame comprising:
a base;
a front left pillar extending from the base;
a front right pillar extending from the base;
a rear left pillar extending from the base;
a rear right pillar extending from the base;
a top front beam extending between the front left pillar and the front right pillar;
a rear front beam extending between the rear left pillar and the rear right pillar;
a top left beam extending between the front left pillar and the rear left pillar; and
a top right beam extending between the front right pillar and the rear right pillar, wherein the frame is monolithic;
a front plate coupled to the base and the top front beam so that the front plate contacts the front left pillar;
a rear plate coupled to the base and the top right beam, wherein the frame, the front plate and the rear plate define a support structure; and
a transmission module comprising a chassis, a laser module and an optical lens module, wherein the transmission module is slidably coupled to the support structure so that the slidable coupling restrains the transmission module to the support structure in five degrees of freedom, and wherein the chassis of the transmission module is secured to at least one of the front plate and the rear plate with a first fastener so that the first fastener and the slidable coupling restrain the transmission module to the support structure in six degrees of freedom.

12. The optical module of claim 11, wherein the front plate comprises a first groove facing the rear plate,
wherein the chassis of the transmission module comprises a front rail, and
wherein the slidable coupling comprises the front rail engaging with the first groove.

13. The optical module of claim 12, wherein the rear plate comprises a second groove facing the front plate,
wherein the chassis of the transmission module comprises a rear rail, and
wherein the slidable coupling further comprises the rear rail engaging with the second groove.

14. The optical module of claim 13, further comprising a second transmission module,
wherein the front plate comprises a third groove facing the rear plate,
wherein the rear plate comprises a fourth groove facing the front plate, and
wherein the second transmission module is slidably coupled to the support structure by a second front rail of the second transmission module engaging with the third groove and a second rear rail of the second transmission module engaging with the fourth groove.

15. The optical module of claim 13, further comprising:
a galvanometer mirror assembly,
wherein the base comprises a central mounting block coupled to the galvanometer mirror assembly,
wherein the rear plate comprises a faceted recess, and
wherein the faceted recess engages with side surfaces of the central mounting block.

16. The optical module of claim 15, wherein a light transmission opening is defined between the front plate, the base, the front right pillar, and the top front beam,
wherein the central mounting block and the galvanometer mirror assembly are positioned so that a laser beam emitted from the transmission module reflects off the galvanometer mirror assembly and through the light transmission opening.

17. The optical module of claim 11, wherein the frame further comprises a left mounting block extending from the base and the rear left pillar, and a right mounting block extending from the base and the rear right pillar, and
wherein a left side of the rear plate is coupled to the left mounting block with a second fastener and a right side of the rear plate is coupled to the right mounting block with a third fastener, so that a bottom side of the rear plate contacts the base.

18. The optical module of claim 17, wherein the left side of the rear plate is coupled to the top left beam with a fourth fastener and the right side of the rear plate is coupled to the top right beam with a fifth fastener.

19. The optical module of claim 11, wherein the base of the frame defines a first slot and a second slot;
wherein a first bracket is positioned in the first slot and a second bracket is positioned in the second slot, and
wherein the front plate is coupled to the first bracket with a sixth fastener and to the second bracket with a seventh fastener so that a bottom side of the front plate contacts the base and a left side of the front plate contacts the front left pillar.

20. The optical module of claim 19, wherein front plate is further coupled to the chassis further an eighth fastener extending through the top front beam, so that a top side of the front plate contacts the top front beam.
